(19) United States
(12) Patent Application Publication
(10) Pub. No.: US 2007/0151341 A1
(43) Pub. Date: Jul. 5, 2007

(54) Device and method for measuring flexural damping of fibres

(76) Inventors: Edoardo Mazza, Otelfingen (CH); Davide Valtorta, Dubendorf (CH); Jacqueline Vollmann, Zurich (CH)

Correspondence Address: OSTROLENK FABER GERB & SOFFEN, 1180 AVENUE OF THE AMERICAS, NEW YORK, NY, 100368403, US

(21) Appl. No.: 10/582,416

(22) PCT Filed: Dec. 7, 2004
(86) PCT No.: PCT/EP04/53313

§ 371 Date: Aug. 11, 2006

(30) Foreign Application Priority Data
Dec. 11, 2003 (EP) 03405890.9

(51) Int. Cl. G01H 13/00

(52) U.S. Cl. 73/579

(57) ABSTRACT

The present invention is directed to a device and a method for measuring flexural damping in fibres. The device comprises a transducer coupled to the fibre. The transducer measures flexural vibration in the fibre. The device includes a light barrier having a light emitter and a light receiver arranged in line to each other and approximately perpendicular to the fibre. A light beam is emitted by the light emitter and received by the light receiver and is periodically interrupted by the fibre during vibration. A phase delay between an excitation signal and the fibre response is obtained from the electrical signal of the interrupted light beam.

The present invention is directed to a method and a device for measuring the flexural damping of fibres according to the annexed claims.

Damping in a mechanical system is one of the parameter that determines the dynamic response to an excitation. It is a measure of the energy dissipated during the motion. It limits the duration of a free vibration of a mechanical structure and determines whether a forced vibration can lead to resonance or not and, in case of resonance, the maximum amplitude of the motion. Damping characterizes the capability of the system to mitigate the transmission of mechanical energy from a power source to its surroundings. Material damping depends on the microstructure of the material and represents therefore a useful index to characterize the microscopic mechanisms of energy dissipation.

Fibers are very widely used mechanical structures with various functions, such as signal transmission (e.g., optical fibers), force transmission (e.g., carbon fibers in composites materials), protection and coating (e.g. textile tissues, or human hairs), objects detections and characterization (e.g. rat whiskers). For many of these applications, and in particular when the fibers are “free standing” (i.e. not imbedded in a matrix), the fibers are subjected to flexural deformations and flexural vibrations. Their flexural damping characteristics influence to a great extent the fiber's mechanical behavior and therefore their functionality. As an example, for the optical fibers used in position or rotation sensors the measurement disturbances due to mechanical vibrations depends on the fiber's damping characteristics. As a further example, the characteristics of a paintbrush (its “softness” and its ability to facilitate even spreading by the painter) are influenced by the flexural damping of the brush fibers. Studies on fiber's damping characteristics can be found in the literature for different fibers and applications, such as (i) polymer fibers, in which the material damping or loss factor changes with temperature and frequency identifying glass transition points; (ii) rat whiskers, which rats use as very sensitive receptors; (iii) human hair, showing how specific treatments modify the stiffness and the damping of the hairs.

As stated in the paper “Material damping: an introductory review of mathematical models, measures and experimental techniques” by C. W. Bert (Journal of Sound and Vibration, 1973, 29(2), pages 129-153), there are four methods for measuring material damping: 1.) Non-resonant forced vibration, 2.) Decay of free vibration, 3.) Resonant response and 4.) Wave propagation method.

In the so-called Non-Resonant Forced Vibration an oscillating strain (sinusoidal or other waveform) is applied to a sample and the resulting stress developed in the sample is measured. For elastic solids, the stress is proportional to the strain amplitude, and the stress and strain signals are in phase. For ideal fluids, the stress is proportional to the strain rate. Here, the stress signal is 90° out of phase with the strain signal. The stress signal generated by a viscoelastic material can be separated into two components: an elastic stress in phase with the strain, and a viscous stress in phase with the strain rate (90° out of phase with the strain). The ratio of the elastic stress to strain is the elastic (or storage) modulus E′; the ratio of the viscous stress to strain is the viscous (or loss) Modulus E″, when testing is done in tension or flexure. The ratio of the viscous modulus to the elastic modulus is the tangent of the phase angle shift 5 between the stress and strain vectors, E″/E′=tan δ. This measures the damping ability of the material. This technique is not suitable for measuring flexural damping of thin fibres (with cross sectional dimensions down to a few micrometers) since the values of forces required for the deflection of the fibres are very small. A damping measurement however can be obtained with this technique for axial deformation in thin fibres.

For a mechanical structure, the decay of the free vibration amplitude at the frequency F with time t follows the exponential function e^{-γt}, γ=tan δ·F·π, and is therefore characterized by the damping factor δ; A method called Decay of Free Vibration is based on this phenomenon and requires the amplitude of the motion of the free vibrating structures to be determined. This represents an important disadvantage, when applied to a thin fibre. In fact, quantifying the amplitude of the flexural motion of a thin fibre is a very difficult task. One application of this method is described in the paper “Mechanical Characteristics of Rat Vibrassae: resonant frequencies and damping in isolated whiskers and in the awake behaving animal” (The Journal of Neuroscience, Jul. 23, 2003) by Hartmann et al., in which a high speed camera is used to monitor the flexural motion of rat-vibrissae. A time consuming evaluation procedure and expensive equipment are the main disadvantages of this technique. An interesting application of the free decay method for flexural damping measurement in fibres is presented in “Dynamic Modulus and Damping of Boron, Silicon Carbide, and Alumina Fibres” (Ceramic engineering and science proceedings/publ.: American Ceramic Society. Vol. 1, 1980), by DiCarlo and Williams: there, fibres motion is measured by a capacitive sensor. The main problem with this technique is that it only applies for conductive materials: in order to study the behaviour of high-resistivity fibres a thin gold coating had to be added (thus substantially jeopardizing the original fibre damping measurement).

In the method called the Resonant Response Method, the material damping is measured from the amplitude or from the phase curve at resonance. A standard application of this method is described in the ASTM document E 756-98 “Standard Test Method for Measuring Vibration-Damping Properties of Materials”: The amplitude curve is acquired and the damping is extracted from the so-called Half Power Bandwidth. The slope of the phase curve at resonance can also be used for determining the damping coefficient, as for example in the dynamic viscosimeter described in patent EP 0297032 A1: there the damping of a torsional oscillator in contact with a fluid is related to the viscosity of the fluid. With the resonant response method, the motion of the vibrating structure has to be measured in order to determine the phase or amplitude curve. Typically, two transducers are required: one to apply the excitation force, the other to measure the response of the vibrating structures. The application of this approach for thin fibres or whiskers in flexural vibration is very cumbersome, since the deflection cannot be inferred from a sensor without affecting the mechanical system (and therefore jeopardizing the damping measurement).

In U.S. Pat. No. 5,269,181 the Half Power Bandwidth Method is used to measure the damping of a fibre held in tension by fixing it at its upper end, hang it vertically down and secure a mass on its lower end. As described in U.S. Pat. No. 5,269,181 this method provides measurement of longitudinal damping in fibres. The measurement requires a mass to be fixed at one extremity of the fibre, thus leading to longitudinal pre-stretch of the fibre, which in turn influences the outcome of the measurement. This method is limited to vibration frequencies higher 25 Hz and fibres not longer than 183 mm.

The wave propagation method, mentioned above as the fourth method, is not suitable for measuring the flexural damping of thin fibres either, since the measurement of the fibre's displacement due to wave propagation is even more difficult as for the resonant response measurement.

The known devices for measuring damping of fibres are based on one of the above described methods and do not provide the resolution required and/or they are too slow and complicated in handling, i.e. for huge amounts of samples or for a fast quality assurance on site. Furthermore, they are often expensive in production and maintenance because of their complexity.

It is an object of this invention to provide a device and a method for measuring accurately and fast flexural damping in fibres or fibre like materials and which is applicable not only in laboratory environment but also in industrial processes. This object is achieved with a device according to claim 1 and method according to claim 12.

A first embodiment of a device according to the present invention comprises a transducer (actuator), which is mechanically connected to one end of a fibre (fibre like material). The transducer may serve as support for the fibre, e.g. such that it is attached to it with one end of its extremities,

To determine the flexural damping of a fibre the transducer induces a flexural vibration into the fibre by one extremity of the fibre substantially perpendicular to the length direction of the fibre. By an optical sensor the period of the deflection of the fibre around its initial position is measured. In a preferred embodiment the optical-sensor comprises a light barrier with a light, emitter and a light receiver arranged in line with each other and approximately perpendicular to the attachable fibre, thus that a light beam emitted by the light emitter and received by the light receiver is periodically interrupted by the fibre during vibration. The phase delay between excitation signal and fibre response is obtainable from an electrical signal of the light receiver actuated by the light beam and interrupted by the vibrating fibre. The measurement of the damping coefficient can be carried out in a very short time, depending on the set up of the device, within a few minutes. Therefore this embodiment is suitable for industrial processes as well as for laboratory applications.

A preferred way for actuating a flexural vibration in a fibre is by a piezoelectric transducer. Other transducers, such as electromagnetic transducers (e.g. a coil) or an electrical motor are applicable too. In order to mechanically connect a fibre to a transducer, the transducer can be equipped with a suitable surface to fix the fibre e.g. with glue, tape. In a preferred embodiment the transducer serves a holding device for the fibre. Less effort is needed if a mechanical clamping device is provided for fixing the fibre.

Good results are obtained by using a laser or a photo diode as the light emitting device in the optical sensor. Suitable is the use of a reflected light beam from a laser interferometer or the use of an electromagnetic sensor or a capacitive sensor for obtaining a periodical disturbance of an electrical signal due to the motion of the vibrating structure.

By arranging the optical sensor and the transducer movable with respect to each other and/or the transducer and/or the fibre (axis of fibre), the device can be adapted to fibres of different length. A further advantage can be obtained if the transducer is arranged in such a way that it is movable between a first position and a second position, in which first position the attachable fibre is aligned in a more or less horizontal direction and in which second position the fibre is aligned in an approximately vertical direction. In this case the influence of gravitation can be studied with the same sample and under unchanged environmental conditions. For a series of measurements it is advantageous to have the movement of the transducer and the light barrier engine-driven. In most cases engine-driven movement can be accomplished more precisely than hand implemented movement.

In order to enhance the resolution of the light barrier an aperture with a suitable opening can be placed in front of the receiver, preferably concentrically with the receiver. By adjusting the aperture and the position of the aperture, the device can be calibrated. The diameter of the opening of the aperture preferably corresponds with the diameter of a fibre to be measured, respectively its deflection. When the diameter of the opening is e.g. in the micrometer range, it enables the measurement of damping in fibres with cross sectional dimensions in the range of 10⁻⁶ meter. The aperture is preferably adjustable to the size of the fibres to be measured. Calibration of the measuring device can be done by adjusting the transducer and/or the optical sensor (light emitting device, light barrier or diaphragm).

In a preferred embodiment all relevant parts of the device, such as transducer, optical sensor and fibre to be tested, are placed in an environmental chamber, in order to allow an accurate control of the measurement conditions such as temperature and/or pressure and or humidity control.

In general words the method used for determining flexural damping in fibres can be described as a method of determining the phase curve of a resonant system from the periodic disturbance of an electrical signal, such as the signal from a light barrier interrupted by the lateral motion of a vibrating fibre. In detail the method comprises the steps of: mechanically connecting, e.g. fixing, the fibre with its one extremity to a transducer; exciting the fibre to be measured into flexural vibration at a wide range of frequencies, carrying out a fast scan in order to identify the resonance frequencies of the fibre; performing a series of measurement by exciting the fibre into flexural vibration at frequencies around one specific resonance frequency; analysing the acquired data in order to determine the phase curve and its slope. By repeating the measurement at different resonance frequencies of the fibre, the frequency-dependency of the flexural damping in the fibre can be investigated.

Special embodiments of a device according to the herein described invention can be used in a sensors, e.g. for detecting specific molecules in a gas or a liquid. Further applications like application of this method for damping measurement in the cantilever of an atomic force microscope are thinkable as well.

In the following figures, embodiments of the invention are described exemplarily. Same elements in the figures are indicated by the same indices. The examples given in the figures are not limiting, thus i.e. specific elements of the examples my be combined in a way not explicitly demonstrated in the figures. Embodiments with features of the same functionality not explicitly shown, but known by a person skilled in the art without a great effort, are included.

The figures are showing:

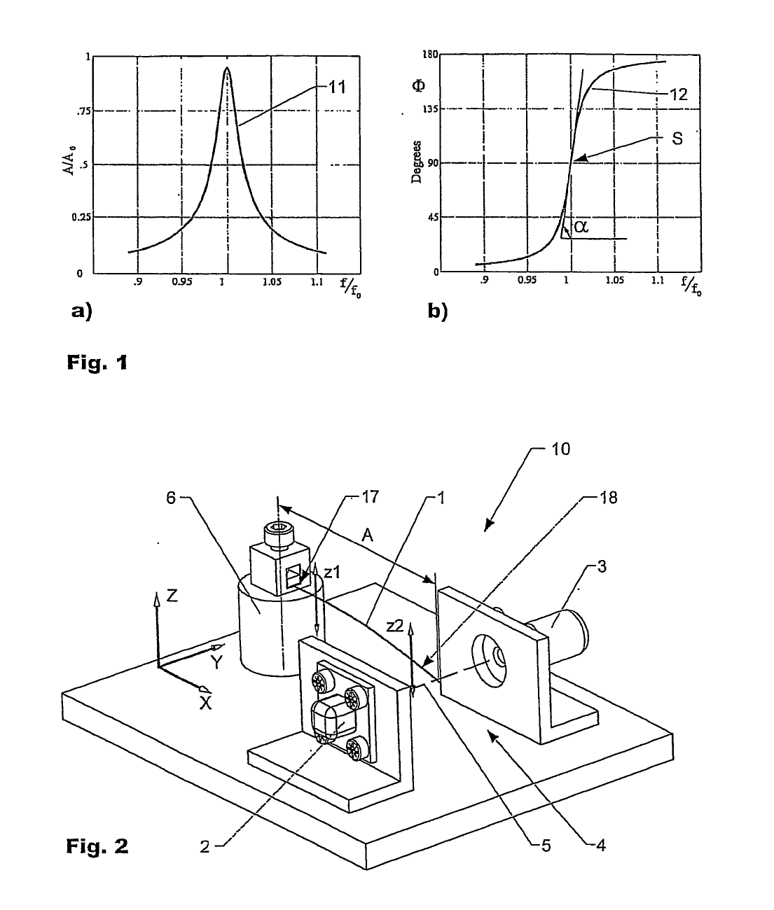

FIG. 1: typical resonance curves;

FIG. 2: a first embodiment of the core part of the invention for damping measurement in fibres;

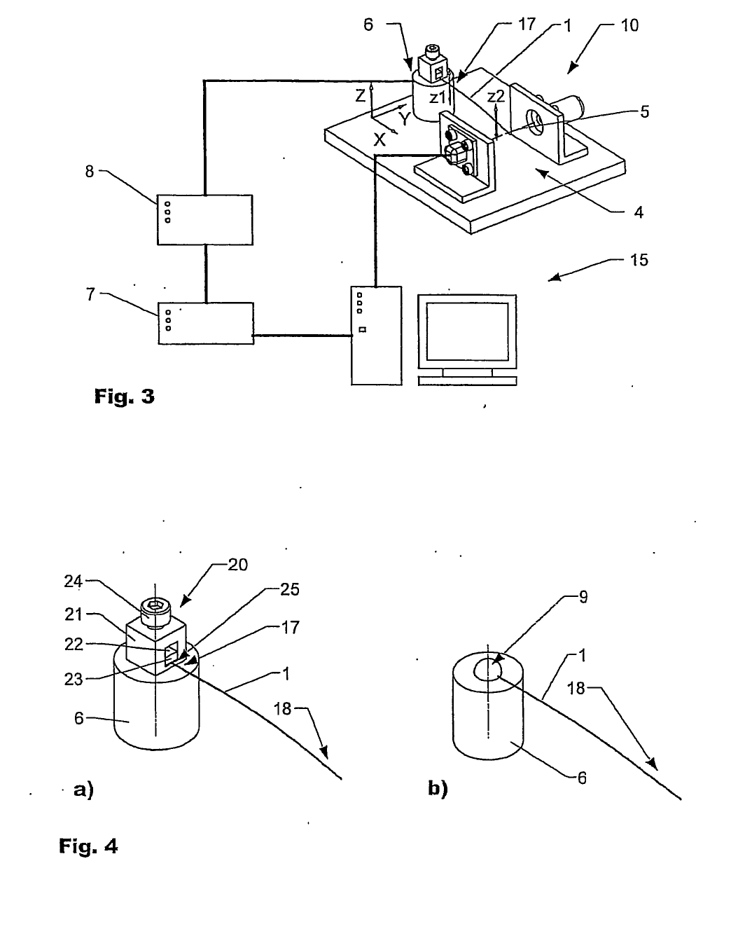

FIG. 3: the embodiment of the core part of the invention according FIG. 2 completed according to the invention with an electronic data processing and data storage device;

FIG. 4: two embodiments of fixation of the fibre to the transducer;

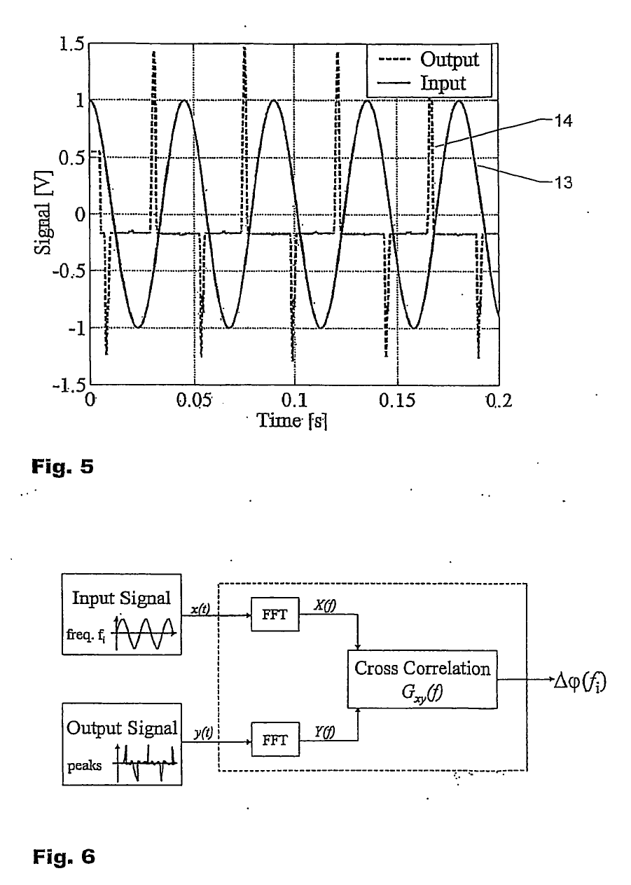

FIG. 5: an example of input and output signals;

FIG. 6: a scheme of the data analysis procedure;

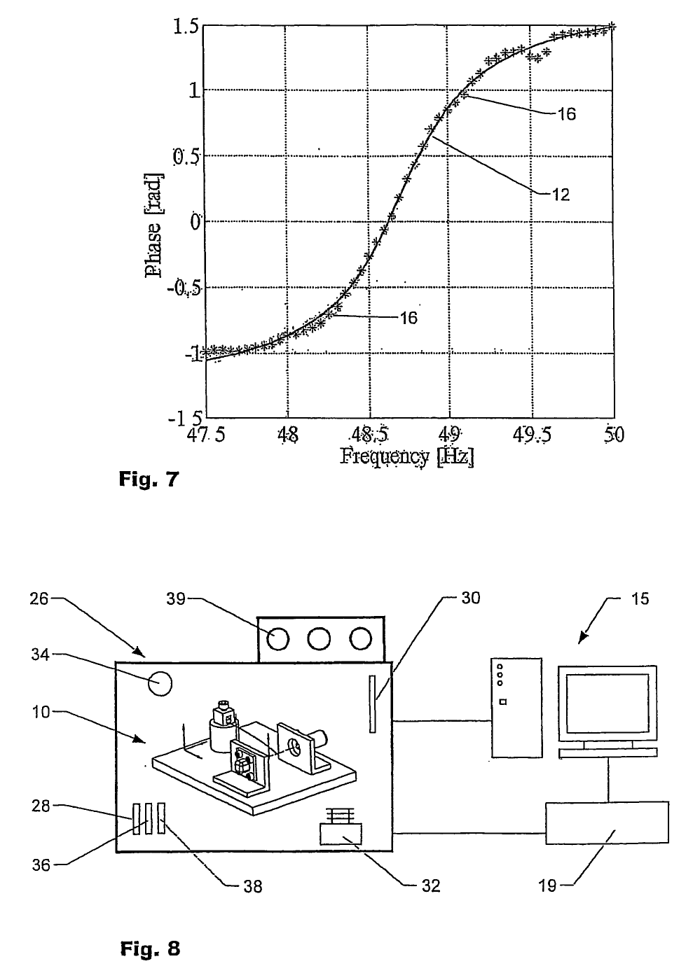

FIG. 7: an example of measured phase curve;

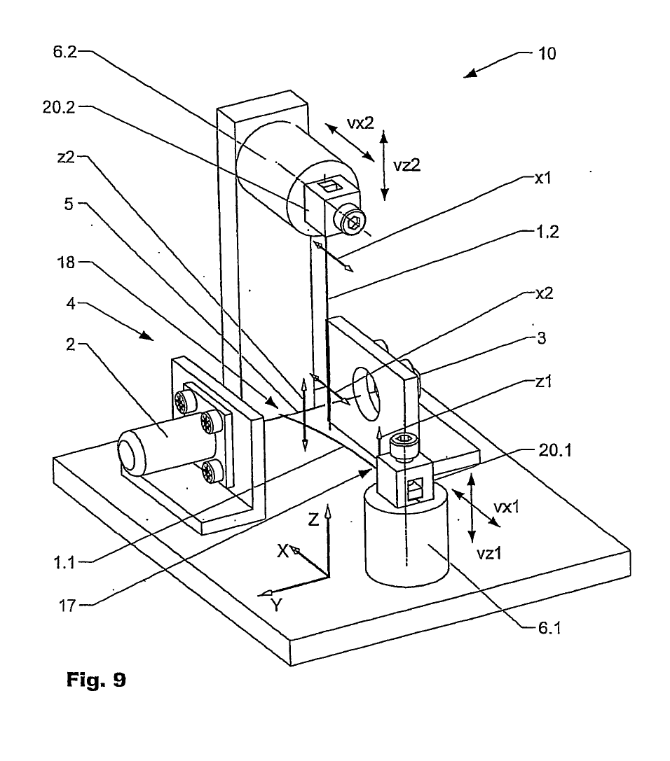

FIG. 8: a second embodiment of the invention with a chamber allowing the control of pressure, humidity and temperature;

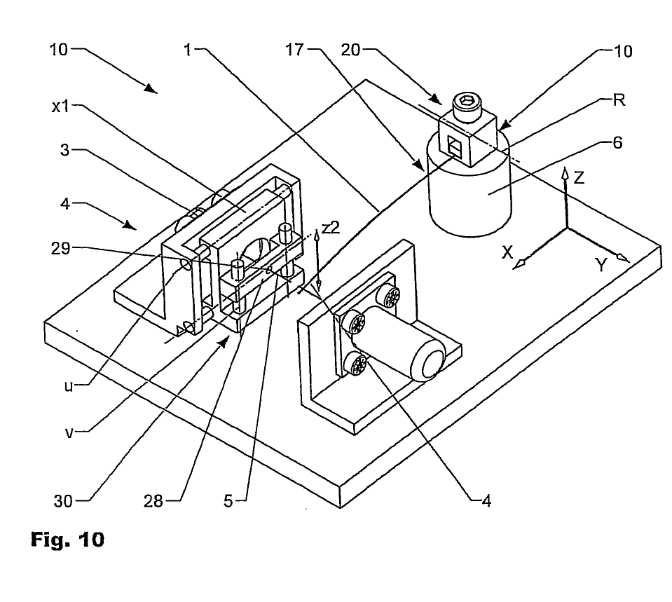

FIG. 9: another embodiment of the core part of the invention with two transducers;

FIG. 10: a further embodiment of the core part of the invention with a pin hole for very thin fibres.

FIG. 1 schematically shows curves 11, 12 that characterize a resonance response of a mechanical structure due to a periodic deflection. From amplitude curve 11 (FIG. 1a) it can be schematically retrieved how damping influences an amplitude A (A₀=deflection of excitation) as a function of frequency F and a phase Φ (phase curve 12, FIG. 1b). In particular, phase curve 12, as shown in FIG. 1b, describes the frequency dependency of the phase angle Φ between excitation and motion, and this angle is 90° at the resonance frequency F₀ (F/F₀=1). The slope of the phase curve 12 (point S) at the resonance frequency is inversely proportional to the damping of the system. Damping is related to the slope a of the phase curve at the resonance frequency Fᵣₑₛ by the formula: δ=2(α·Fᵣₑₛ).

By the present invention the problem of measuring the damping coefficient δ is reduced to the problem of measuring the phase curve of a vibrating system, e.g. a thin fibre. Because the acquisition of the lateral deflection of a thin fibre is very difficult, it is advantageous to be able to retrieve information regarding damping from a phase curve. Due to this no influence on the system is necessary. The application of a contacting sensor to the fibre would affect the mechanical system, and therefore jeopardize the damping measurement. Optical methods known from the state of the art fail due to the small dimensions of the fibre and the resulting difficulties to follow the motion of the fibre through the whole vibration cycle or even to observe the decay of the amplitude only. A system with very high sensitivity is required in order to measure the vibration amplitude by capacitive sensors. In the present invention this problem has been solved by determining the phase curve from the binary signal of a sensor, e.g. an optical sensor such as a light barrier, in which a light beam between a light emitting diode and a phototransistor is interrupted periodically by the fibre during its lateral motion. Thus, with the method according to the present invention the motion needs to be detected, but not to be measured.

FIG. 2 shows a device 10 for measuring flexural damping of a fibre 1. The fibre 1 is connected and supported by a transducer 6, which serves to deflect a first end 17 of the fibre 1 laterally in direction z1 such that the fibre 1 oscillates flexural in a xz-plane about an initial free position (referenced rest position). A second end 18 of fibre 1 vibrates freely between a light emitter 2 and a light receiver 3 of an optical sensor 4. During its motion z2 it passes periodically (two times per period) through a light beam 5 extended between the light emitter 2 and the light receiver 3. An electrical signal generated by the light receiver 3 of the optical sensor 4 is transferred to a data collecting and processing unit (see FIG. 3) wherein the damping behaviour is calculated. For determining the flexural damping in the fibre 1, the phase curve is determined by measuring and processing the electrical signal of sensor 4.

Depending on the set-up of the testing device, it is possible to apply a different excitation than a lateral deflection. Alternatively it is possible to rock the device to be tested back and forth at a certain frequency around an axis (not displayed), e.g. of a powered seesaw. Overlay of different excitation is possible if appropriate.

The method for measuring the damping of a fibre 1 by device 10 comprises the following steps: Mechanically connecting, e.g. fixing, the fibre 1 with its one extremity 17 to a transducer 6; actuate fibre 1 over a wide range of frequencies, carrying out a fast scan in order to identify the resonance frequency F₀ of the fibre 1; performing a series of measurement by actuating the fibre 1 at frequencies around a resonance frequency found; analysing the acquired data in order to determine the phase curve and its slope.

The fibre analysed can be one of the group of artificial fibres and natural fibres. Artificial fibres can be silicon whiskers, polyvinyl whiskers, aramid fibres, carbon or silicon carbide fibres, glass fibres, metal fibres and so on, natural fibres can be rat whiskers, cat whiskers, human hairs and so on.

FIG. 3 shows an embodiment of a device 10 according to FIG. 2 in a set-up for measuring flexural damping in a fibre 1. In this example a piezoelectric column 6 is used to actuate a flexural vibration in fibre 1 (xz-plane) by deflecting a first end 17 in z-direction. However, conceivable are other transducers 6, e.g. a remotely mounted instrument hammer or a coil driven electromagnetic device (similar to the membrane of a loudspeaker), power driven joining rod or a capacity driven transducer. In the shown embodiment the transducer 6 is driven by a sinusoidal voltage generated by a function generator 7 and if necessary amplified by an amplifier 8. The fibre 1 is at one extremity 17 rigidly connected with the transducer 6, e.g. by glue 9 or by a mechanical device 10 (see FIG. 4). The deflection induced by transducer 6 is typically, depending on the setup of the testing device 10 and the specimen to be measured, in the range of 10 μm to 1 mm.

The fibre 1 is arranged such that it can freely deflect at its other end, similar to a cantilever beam set-up fixed only on one side. When actuated, the fibre 1 preferably vibrates in the first flexural mode in a plane (xz-plane) perpendicular to the light beam 5 in the light barrier 4. Advantageously transducer 6 and light barrier 4 with light source 2 and light receiver 3 are mounted on a frame in such a way that they are movable relative to one another in horizontal and/or vertical direction. Thus, the damping measurement can be carried out with fibres 1 of different length. Depending on the set up of the device and the material to be tested, a typical length of a fibre 1 is in the range of 10 mm to 100 mm with a typical diameter in the range of 20 μm to 200 μm. Other dimensions are possible.

The input signal of the function generator 7 and the output signal of the light receiver 3 are lead to a data processing and data storage device 11, where the analysis of the reported signals and the calculation of the material properties especially the damping coefficient δ are accomplished.

FIG. 4 a) shows a clamping device 20 for rigidly connecting a first end 17 of a fibre 1 to a transducer 6. However, depending on the setup of the device, no direct connection between the clamping device 20 and the actuating device 6 is necessary. The clamping device 20 may be connected remotely to the actuating device 6 if appropriate. Clamping device 20 comprises a block 21 with an opening 22 in which a jaw 23 is arranged. By tightening a screw 24 the jaw 23 may be pressed against a bottom surface 25 of opening 22 in order to mechanically fix fibre 1. The clamping device 20 can be provided with one or more grooves (not visible) adapted to fibres of different diameters.

As depicted in FIG. 4 b) the fibre 1 can be fixed to the transducer 6 by any suitable glue 9. Said glue 9 has to be adapted to the specific parameters of each experiment like, surface properties of the support surface of the transducer 6, fibre material, temperature, humidity, pressure and so on. Of course every suitable other way to fix the fibre to the transducer may be chosen without changing the main idea of the invention.

FIG. 5 shows an example of a periodic driving signal 13 as generated by a function generator 7 (see FIG. 3) having a specific frequency and a typical outpost signal 14 of an optical sensor 4, in the present case a laser interferometer (for reference signs see FIG. 3). The optical sensor 4 comprises a light receiver 3 (e.g. a photo transistor) which is lighted on by a light beam 5 of a light source 2. The optical sensor 4 generates a peak output when the light beam 5 is interrupted by a fibre 1 passing through it. As shown in FIG. 3, such a driving signal 13 and output signal 14 are captured by a data processing unit 15, e.g. a computer comprising a standard data acquisition card. The data processing unit 15 may be used to collect and/or to process the driving signal and the output signal 14.

FIG. 6 schematically shows a flow chart of an analysis process of an input signal (driving signal) and an output signal as shown in FIG. 5. For each frequency with which a fibre is activated, the phase angle between excitation (driving lateral deflection of transducer) and the lateral motion of the fibre is determined using statistical methods for data analysis. These methods are widely applied in modal analysis techniques, where noise affects the input and output signals. Correlation functions are used to describe the average relation between random variables. In particular, the Cross Correlation Function between two signals x(t) and y(t) is defined as:

$${R}_{xy} ( τ ) = \frac{1}{T} {\int }_{0}^{T} x ( t ) y ( t + τ ) ⅆ t \qquad ( 1 )$$

The Cross Spectral Density Function (CSD) between the two signals is defined as the fourier transformation of the cross correlation:

$${G}_{xy} ( F ) = 2 {\int }_{- ∞}^{+ ∞} {R}_{xy} ( τ ) {ⅇ}^{- ⅈ2π F τ} ⅆ τ \qquad ( 2 )$$

The CSD can be written as in equation (3), where τ(F) is the time delay between x(t) and y(t) at frequency F.
G_{xy}(F)=|G_{xy}(F)|e^{-iθ}^{_{xy}}^{(F)}θ_{xy}(F)=2πFτ(F) (3)

The phase θ_{xy} of the CSD corresponding to the exciting frequency identifies the phase delay. The CSD can be found as a built-in function in commercial software.

For each frequency the phase delay is determined. Several frequencies are tested leading to the determination of the phase curve. An example is given in FIG. 7.

FIG. 7 shows typical graph of a phase delay curve 12 measured by a device according to the present invention. With a simple curve fitting algorithm, the slope of the phase curve and thus the damping coefficient can be determined from these data. Test points 16 are schematically displayed.

The method for determining material damping in fibres according to the present invention thus can be summarized as a method of determining the phase curve of a resonant system from the periodic disturbance of an electrical signal from a light barrier interrupted by the motion of the vibrating structure. Using the procedure described above the damping measurement may be performed in a very short time. With a first embodiment it only took a few minutes. In addition, the statistical data analysis provides directly a measure for the confidence interval of the evaluated damping coefficient.

FIG. 8 shows a device 10 arranged inside an environmental chamber 26. Thus the measurement can be prevented from external perturbation. The environmental chamber 26 here shown is equipped with a heating/cooling device 39, a thermostat 30 for temperature control, a vacuum/pressure pump 32 and a manometer 34 for pressure control, and humidifier/air dryer 36 with a hygrostat 38 for humidity control, thus the experimental conditions can be accurately controlled (these parameter have sometimes an important influence on the material damping). For applications at high temperatures or other severe environmental conditions suitable transducers (e.g. electromagnetic transducers) can be used, a light beam can be introduced into the test chamber through a window, a mirror can be used for reflecting back the light beam outside the chamber, such that the light emitter and receiver devices remain outside the chamber. All parameters and the device 10 are preferably controlled by a data processing unit 15 and data control unit 19, Parameters may be controlled manually by display means 39.

FIG. 9 shows a further embodiment of a device 10 for measuring material damping of fibres 1.1, 1.2. In contrary to the embodiment of FIG. 2, the herein shown device comprises a first and a second transducer 6.1, 6.2 having a first and a second clamp 20.1, 20.2 to clamp fibres 1.1, 1.2. While the first transducer 6.1 and the first clamp 20.1 are arranged horizontally, the second transducer 6.2 and the second clamp 20.2 are arranged vertically. The first fibre 1.1 clamped by the first clamp 20.1 is arranged horizontally (in the general direction of the x-axis), similar to the embodiment as shown in FIG. 2. In contrast to this the second fibre 1.2 is arranged in vertical direction (in the general direction of the z-axis).

Possible influences of the pre-deformation of long thin fibres due to gravitational forces can be studied performing comparable studies with both embodiments of the inventive device. Instead of two transducers 6.1, 6.2 and two clamps 20.1, 20.2 the first transducer 6.1 and the first clamp 20.2 may be arranged that they can be brought from a first position to a second position, In order to facilitate such studies the transducer 6.1 can be arranged movable at a frame (not explicitly shown). To calibrate the device 10 the transducers and/or the clamps 20.1, 20.2 are arranged movable in x- and in z-direction (indicated by arrows vx1, vz1, vx2, vz2) such that fibres to be measured may be positioned with respect to light beam 5 of sensor 4, Cables and other electrical connections to transfer data between the different elements are not displayed.

The first transducer 6.1 is used to actuate the first fibre 1.1 at a first end in general z-direction as indicated schematically by arrow z1 (not true scale). Due to this the second end 18 of first fibre 1.1 deflects periodically (indicated by arrow z2) interrupting the light beam 5 of sensor 4 periodically.

The second transducer 6.2 is used to actuate the second fibre 1.2 at a first end in general x-direction as indicated schematically by arrow x1 (not true scale). Due to this the second end 18 of second fibre 1.2 deflects periodically (indicated by arrow x2) interrupting the light beam 5 of sensor 4 periodically.

FIG. 10 shows a further embodiment of a device 10 for measuring flexural damping of a fibre 1 which is excited by an actuator 6. The fibre 1 is mechanically connected to the actuator 6 by a clamp 20. The actuator 6 actuates fibre 1 by rocking a first end 17 of fibre 1 it back and forth about an axis R perpendicular to xz-plane (parallel to y-axis). Due to this a second end 18 of fibre 1 moves up and down (indicated by arrow z2) about a referenced free position periodically interrupting light beam 5 of sensor 4. In front of light receiver 3 a plate 28 with a pin hole 29, working as an aperture, is arranged. The pin hole 29 serves to increase the precision of device 10 such that fibres 1 with smaller diameters and less deflection may be detected. Aperture 29 is mounted on a mechanical stage 30 movable along a first axis u in general x and along a second axis v in general z direction, such that sensor 4 may be calibrated.

The method according to the present invention can be applied for damping measurement in fibres 1 with cross sectional dimensions down to a few micrometers. For very thin fibres and small deflections the resolution of the light barrier 4 can be improved by partially covering the light receiver 3 with a plate 28 having a pin hole 29 with a suitable diameter, e.g. in the range of 10 μm adapted to the diameter of the fibre 1. The noise of the output signal can be reduced.

Various templates 28 with one or more pin holes 29 (more than one signal per cycle) of different diameters can be provided by mounting them on the mechanical stage 30. The exact positioning of the pin hole 12 in front of the light receiver 3, especially concentric to the light receiver 3, can easily be achieved by mechanical stage 30, if suitable adjustable manually or electrically driven.

As described above the device according to the present invention may be also used as a sensor device. Various applications are possible, e.g. a sensor for detecting specific molecules. Using the device as a sensor for specific molecules the fibre 1 may comprise a chemical substance on its surface serving as a trap for the molecules which have to be detected. When such molecules are captured on the surface of an appropriate fibre, the damping properties of the fibre 1 will change. Such a sensor can be used e.g. as a gas-sensor or as a part of an artificial nose. For an artificial nose a plurality of such sensors trapping different molecules can be connected. Inventive devices formed as small chips are particularly suitable for this application.

In order to use the inventive device as a binary flow control unit it has to be applicable in a flow channel. As the fibre 1 can be moved out of its position interrupting the light beam 5 by a minimum flew, the device can be used wherever it is necessary to register every slightest flow, but where it is not necessary to know the flow direction or the flow rate.

1. Device for measuring flexural damping in a fibre comprising: a transducer driven by an input signal to excite the fibre laterally at different frequencies (F), such that the fibre vibrates perpendicular to its axis (x2, z2) about a rest position, and a sensor to detect fibre motion in order to measure phase delay between the input signal and a output signal of the sensor.

2. Device according to claim 1, wherein the transducer is mechanically connected to the fibre, such that one end of the fibre is deflected parallel in a first direction (z1) and/or such that one end of the fibre is rocked around a first axis (R).

3. Device according to claim 1, wherein the transducer is mechanically connected to a clamp for clamping the fibre at a first end.

4. Device according to claim 1, wherein the transducer is at least one selected from the group consisting of a piezoelectric transducer, an electromagnetic transducer, an electrical motor and a capacitive transducer for exciting the fibre.

5. Device according to claim 4, wherein the transducer includes a clamp for clamping the fibre or a surface for fixing the fibre by the use of glue.

6. Device according to claim 1, wherein the sensor is a light barrier having a light emitter generating a light beam and a light receiver arranged such that the light beam is interrupted by the fibre during vibration (x2, z2).

7. Device according to claim 6, wherein the sensor includes an adjustable aperture to adjust the sensor.

8. Device according to claim 6, wherein the light emitter in the light barrier is a laser or a photo diode.

9. Device according to claim 1, wherein a first transducer is arranged such that a first fibre is arranged in a general z-direction, parallel to earth gravity and a second transducer is arranged such that a second fibre is arranged in a general x-direction, perpendicular to earth gravity.

10. Device according to claim 1, wherein a transducer is arranged movable between a first vertical position, such that a fibre is arranged in general z-direction, parallel to earth gravity, and a second horizontal position, such that a fibre is arranged in a general x-direction, perpendicular to earth gravity.

11. Device according to claim 1, wherein the device is arranged in an environmental chamber having at least one selected from the group consisting of means to control the temperature, means to control the pressure, and means to control the humidity inside of the chamber.

12. Method of measuring the flexural damping in a fibre using the device according to claim 1 comprising the following steps: Mechanically connecting the fibre to a transducer; inducing flexural vibration into the fibre; carrying out a fast scan with the excitation signal varying over a wide range of frequencies (F) in order to identify a resonance frequency (F_{O}, _{Res}) of the fibre; performing a series of measurements at frequencies (F) around the resonance frequency (F_{O}, _{Res}) found; and analysing the acquired data in order to determine the phase curve and its slope (α)

13. Method for determining a phase curve of a resonant system from the periodic disturbance in the electrical signal of a sensor due to the motion of the vibrating structure comprising the following steps: inducing a vibration into the system to be measured; carrying out a fast scan with the excitation signal varying over a wide range of frequencies (F) in order to identify a resonance frequency (F_{O}, _{Res}) of the system; performing a series of measurement at frequencies (F) around the resonance frequency (F_{O}, _{Res}) found; and analyzing the acquired data in order to determine the phase curve and its slope α.

14. Device according to claim 7, wherein the light emitter in the light barrier is a laser or a photo diode.
